(19) United States
(12) Patent Application Publication
(10) Pub. No.: US 2016/0350675 A1
(43) Pub. Date: Dec. 1, 2016

(54) SYSTEMS AND METHODS TO IDENTIFY OBJECTIONABLE CONTENT

(71) Applicant: Facebook, Inc., Menlo Park, CA (US)

(72) Inventors: Erez Laks, Tel Aviv (IL); Adam Stopek, Tel Aviv (IL); Adi Masad, Nit Itzhak (IL); Israel Nir, Tel Aviv (IL)

(21) Appl. No.: 14/727,734

(22) Filed: Jun. 1, 2015

(51) Int. Cl. G06N 99/00

(52) U.S. Cl. CPC G06N 99/005

(57) ABSTRACT

Systems, methods, and non-transitory computer readable media configured to determine scores for content items published in an online environment based on at least one machine learning model trained with features associated with the content items. The scores can be associated with probabilities that the content items include objectionable material. A subset of the content items can be selected based on scores of the subset of the content items and satisfaction of a threshold value. It can be determined whether the subset of the content items includes objectionable material.

### FIELD OF THE INVENTION

The present technology relates to the field of content identification. More particularly, the present technology relates to techniques for identifying objectionable content published in an online environment and marked for review.

### BACKGROUND

Today, people often utilize computing devices for a wide variety of purposes. Users can use their computing devices, for example, to communicate and otherwise interact with other users. Such interactions are increasingly popular over a social network.

Some interactions in a social network may include the sharing of content. Content can take a variety of forms. For example, content can include publication of text, images, video, or a combination thereof to a selected audience of the social network. In particular, content can include, for example, images uploaded by a user, images uploaded by others in the social network of the user, descriptions of activities of connections of the user, articles regarding subject matter of interest to the user, advertisements directed to the user, etc. Content unfortunately also can include objectionable material that degrades user experience and otherwise compromises the spirit of and goodwill in productive communication within the social network.

### SUMMARY

Various embodiments of the present disclosure can include systems, methods, and non-transitory computer readable media configured to determine scores for content items published in an online environment based on at least one machine learning model trained with features associated with the content items. The scores can be associated with probabilities that the content items include objectionable material. A subset of the content items can be selected based on scores of the subset of the content items and satisfaction of a threshold value. It can be determined whether the subset of the content items includes objectionable material.

In an embodiment, the features reflect contextual information regarding the content items.

In an embodiment, the features relate to at least one of a user who flagged a content item and a user who uploaded a flagged content item.

In an embodiment, the features include at least one of reporting accuracy, abuse history, gender, age, profile completeness, profile verification, locale, friends counts, account age, number of reporters, language, and topics reflected by the content items.

In an embodiment, the content items include flagged content items.

In an embodiment, the at least one machine learning model is based on a random forest technique.

In an embodiment, the at least one machine learning model includes different machine learning models. The different machine learning models are developed to identify objectionable material in different types of content items.

In an embodiment, the content items are sorted based on the scores.

In an embodiment, the determination of whether the subset of the content items includes objectionable material comprises presenting, via a computer enabled user interface, the subset of the content items for manual review. Labels regarding whether the subset of the content items includes objectionable material are received based on the manual review.

In an embodiment, the at least one machine learning model can be retrained based on the labels.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example content analysis module, according to an embodiment of the present disclosure.

FIG. 2 illustrates an example content processing module, according to an embodiment of the present disclosure.

FIG. 3 illustrates an example functional diagram, according to an embodiment of the present disclosure.

FIG. 4 illustrates an example first method to allow review of flagged content items that may include objectionable material, according to an embodiment of the present disclosure.

FIG. 5 illustrates an example second method to allow review of flagged content items that may include objectionable material, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Identifying Objectionable Content

People can use social networking systems (or services) for various purposes. Users of a social networking system can utilize their computing devices (or systems) to establish connections, communicate, and interact with one another via the social networking system. Users can also provide, create, edit, share, or access content such as images, videos, audio, articles, links, and text. In one example, a particular user of the social networking service can post or publish content items, which can be presented on a page (e.g., profile, timeline, wall, etc.) of the user. Other users, for example, can access, view, or interact with such content items published on the page of the user in accordance with privacy settings or preferences selected by the user. In another example, content items published or posted by the user can be surfaced to other users via news feeds associated with the other users.

Some content items published to a social networking system can include objectionable material. Objectionable material in content items can include pornography, hate speech, bullying, and the like. To identity objectionable material in content items, a social networking system can provide a computer enabled user interface with functionality to allow a user who accessed a content item to flag the content item to indicate her disapproval of the content item based on her belief that it contains objectionable material. The social networking system can monitor the content items that have received one or more flags and then provide such content items for manual review by administrators associated with the social networking system.

As the size of the social networking system grows, the engagement level of its users rises, and the number of content items published within the social networking system increases, administrators can be called upon to review in a relatively short time an immense number of content items that have been flagged. The scale of the review can unduly burden administrators and produce delays that frustrate prompt review and potential takedown of content items including objectionable material. As a result, proliferation of content items including objectionable material within the social networking system can impact the integrity and reputation of the social networking system.

An improved approach to identifying flagged content items including objectionable material overcomes disadvantages associated with conventional approaches. In general, systems, methods, and computer readable media of the present disclosure can identify content items that have been flagged by one or more users of a social networking system or other online environment. Features associated the flagged content items can be identified. In a training phase, a machine learning algorithm can develop a machine learning model for determining a probability that a flagged content item includes objectionable material based on the features and their values. In some instances, a plurality of models can be developed to better analyze various types of flagged content items. Each model can be trained using determinations resulting from manual review by administrators associated with the social networking system regarding whether content items include objectionable material or not. In an evaluation phase, a score associated with a flagged content item that indicates a probability that the content item includes objectionable material can be determined based on the model. Flagged content items can be sorted and ranked according to their scores. A flagged content item that satisfies one or more thresholds can be provided for manual review by administrators of the social networking system and a determination regarding whether the flagged content item includes objectionable material. In this manner, only flagged content items satisfying a threshold value relating to a probability of containing objectionable material are provided for manual review, increasing efficiencies in the identification and remediation of flagged content items within the social networking system.

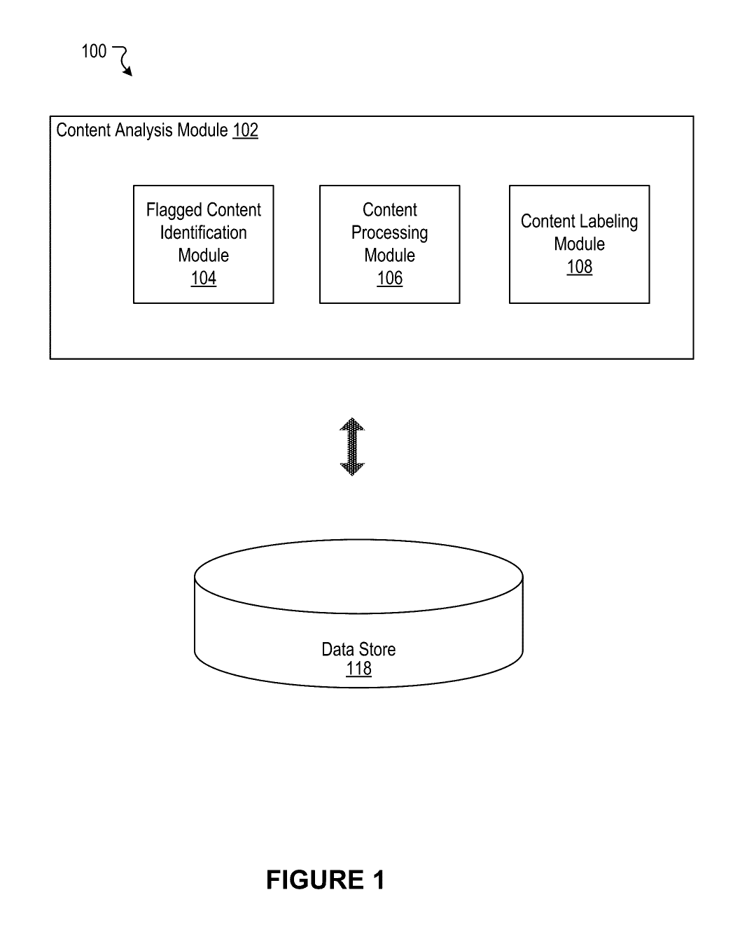

FIG. 1 illustrates an example system 100 including an example content analysis module 102 to identify and redress content items having undesirable, improper, or otherwise objectionable material within a social networking system or other online environment, according to an embodiment of the present disclosure. A content item from which objectionable material can be identified by the content analysis module 102 can include text, images, video, audio, or the like, and any combination thereof. One type of objectionable material includes illegal, indecent, pornographic, illegitimate, inappropriate, hateful, or bullying information. In some embodiments, as discussed herein, the present disclosure can be used in connection with a social networking system that delivers content items to users of the social networking system. Other types of objectionable material can be defined in accordance with various standards provided by administrators of the social networking system, a community of the social networking system, legal regulations, etc.

The content analysis module 102 can include a flagged content identification module 104, a content processing module 106, and a content labeling module 108. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the content analysis module 102 can be implemented in any suitable combinations.

The flagged content identification module 104 can identify content items that have been flagged by users of a social networking system. Content items can be presented to users of the social networking system based on a computer generated user interface provided by the social networking system. The computer generated user interface may include functionality associated with a content item that allows a user to flag or otherwise register a belief that the content item includes objectionable material. The functionality may be implemented in a variety of manners, such as a button or other user input mechanism to allow a user to communicate an objection about a content item. The flagged content identification module 104 can monitor the flagging of content items by users and identify the content items that have been flagged. The flagged content identification module 104 can identify the flagged content items for the content processing module 106.

In some embodiments, the flagged content identification module 104 can identify content items that have not been flagged in addition to or instead of content items that have been flagged. Content items that have not been flagged can be considered, processed, and analyzed in accordance with the principles and techniques described herein with respect to flagged content items.

The content processing module 106 can identify features associated with flagged content items. The features can include various attributes and other contextual information regarding the circumstances surrounding the flagged content item. In a training phase, the identified features can be used to develop a machine learning model to determine a score indicating a probability that a content item includes objectionable material. In some instances, a plurality of machine learning models can be developed to more optimally determine such scores for different types of content items. Each machine learning model can be trained and retrained using determinations about whether a flagged content item includes objectionable material or not based on manual review. Such manual review can be performed by one or more administrators of a social networking system. In an evaluation phase, when flagged content items are newly identified, the features of each flagged content item can be applied to the machine learning model to determine a score indicating a probability that the content item includes objectionable material. The flagged content items can be sorted and ranked according to their scores. A subset of the flagged content items associated with scores that satisfy a threshold value can be provided to the content labeling module 108. The content processing module 106 is discussed in more detail herein.

The content labeling module 108 can facilitate labeling by one or more administrators of a social networking system of the subset of the flagged content items associated with scores that satisfy a threshold value regarding a probability that a flagged content item includes objectionable material. In some embodiments, the content labeling module 108 can present the subset of flagged content items to an administrator of the social networking system using a computer generated user interface. The flagged content items presented to the administrator can reflect any suitable ordering, such as an ordering in a descending manner such that the flagged content items having higher scores and higher probabilities of including objectionable material are presented first. Presentation of the subset of flagged content items as opposed to all flagged content items in this manner can relieve the administrator from the burden of having to manually review all flagged content items. In some embodiments, the score associated with the flagged content item and determined by the machine learning model can be presented alongside with or adjacent to the flagged content item in the computer generated user interface to further inform the manual review by the administrator.

The content labeling module 108 can cause the computer generated user interface to include a prompt for the administrator to label the flagged content item as including objectionable material or not in accordance with manual review by the administrator. The computer generated user interface can provide a suitable user input mechanism to receive a label provided by the administrator in this regard. After a flagged content item is labeled, the social networking system can take appropriate responsive action. For example, a flagged content item that is labeled as including objectionable material can be remediated by the social networking system in a variety of manners, such as removal. As another example, a flagged content item that is labeled as not including objectionable material can be left intact for continued potential access by other users of the social networking system. In addition, labeling of a flagged content item can be used to retrain machine learning models for determining a probability that a flagged content item includes objectionable material.

In some embodiments, the content labeling module 108 need not involve interaction with an administrator of a social networking system. When the machine learning models for determining the probability that flagged content items include objectionable material are deemed to be accurate to a desired level, the content labeling module 108 can label flagged content items based on the probabilities provided by the machine learning models without the need for manual review or other human intervention. For example, when a machine learning model exhibiting a desired level of accuracy produces a probability score for a flagged content item that satisfies a probability threshold, the content labeling module 108 can automatically label the flagged content item as including objectionable material.

The data store 118 can be configured to store and maintain various types of data, such as the data relating to support of and operation of the content analysis module 102. The data can include data relating to, for example, flagged content items, features associated with one or more machine learning models to determine a probability that a flagged content item includes objectionable material, the machine learning models, determinations based on manual review regarding whether or not a flagged content items includes objectionable material, scores associated with flagged content items regarding the probability that the flagged content items include objectionable material, threshold values to select a subset of the flagged content items, etc. The data store 118 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content analysis module 102 can be configured to communicate and/or operate with the data store 118.

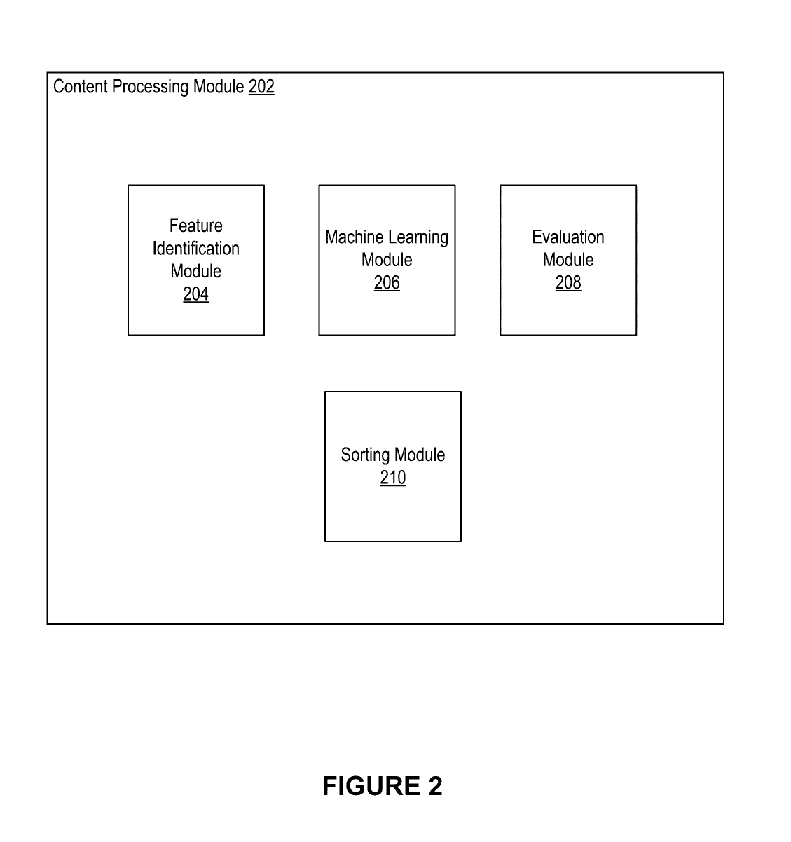

FIG. 2 illustrates an example content processing module 202, according to an embodiment of the present disclosure. In some embodiments, the content processing module 106 of FIG. 1 can be implemented with the content processing module 202. As shown in the example of FIG. 2, the content processing module 202 can include a feature identification module 204, a machine learning module 206, an evaluation module 208, and a sorting module 210.

The feature identification module 204 can identify features and feature values associated with a flagged content item. In a training phase, the features can be used to develop a machine learning model to determine a probability that the flagged content item includes objectionable material. The features can relate to a user who flagged a content item or a user who uploaded a flagged content item. The features also can include any type of content information, attribute information, or other contextual information directly or indirectly relating to a flagged content item. For example, features can include but are not limited to the following:

Reporting Accuracy. This feature relates to a level of accuracy associated with a user in relation to other content items previously flagged by the user. The level of accuracy can be based on an amount of content items previously flagged by the user that were ultimately determined to include objectionable material.

Abuse History. This feature relates to a level of abuse associated with a user in relation to other content items previously uploaded by the user. The level of abuse can be based on an amount of content items previously uploaded by the user that were ultimately determined to include objectionable material.

Gender. This feature relates to gender of the user.

Age. This feature relates to age of the user.

Profile Completeness. This feature relates to whether fields of profile information have been provided by a user of a social networking system to the social networking system. Such profile information associated with the user can include, for example, name, user name, gender, age, marital status, email address, phone number, residential address, payment credentials, etc.

Profile Verification. This feature relates to whether profile information or the identity of a user has been verified.

Locale. This feature relates to the location of a user. The location of the user can include, for example, residential address, business address, temporary address, etc.

Friends Counts. This feature relates to a number of other users with whom a user is connected in a social networking system.

Account Age. This feature relates to a time duration during which a user has had an account with a social networking system.

Number of Reporters. This feature relates to a number of users who have flagged a particular content item.

Language. This feature relates to a language used by a user in connection with a flagged content item. The language can be the language used by the user or the language used in a flagged content item. In addition, the language can be the language used in a computer generated interface presented to the user.

Additional features can relate to contextual information about a flagged content item. For example, one or more features can relate to topics (or subject matter) reflected by a flagged content item. In some embodiments, the feature identification module 204 can include a content classification module (not shown) to identify topics as features. The content classification module can perform classification analyses on flagged content items, including, for example, images and text, based on any suitable processing techniques.

For example, with respect to images, an image classification module can perform a classification analysis on one or more images of a flagged content item to determine the topics reflected by the images. The image classification module can perform the classification analysis by applying a machine learning model (image classifier) to an image to determine probabilities that the image reflects predetermined topics. The image classifier can be based on any machine learning technique, including but not limited to a deep convolutional neural network. In a development phase, contextual cues for a sample set of images can be gathered. Images classes corresponding to various topics can be determined. Correlation of the sample set of images with the image classes based on the contextual cues can be determined. A training set of images can be generated from the sample set of images based on scores indicative of high correlation. The training set of images can be used to train the image classifier to generate visual pattern templates of the image classes. In an evaluation phase, the image classifier can be applied to one or more images of a new flagged content item to determine the topics reflected by the images.

As another example, with respect to text, topic tagging can use contextual information surrounding a flagged content item to determine topics reflected by the flagged content item. The contextual information can include, for example, the identities and profiles of users who interact with the flagged content item, affinities of the users, comments provided in relation to the flagged content item, etc. The contextual information can be used to infer topics reflected by the flagged content item. Other suitable techniques to determine topics reflected by flagged content items can be used. The feature identification module 204 can identify the determined topics as features.

Other contextual information can be used as features. For example, a determination that a flagged content item includes or does not include objectionable material can depend on a feature relating to a relationship between two or more of the following considerations: a user that uploaded the flagged content item, a user that flagged the content item, the flagged content item, and a topic reflected by the flagged content item. For instance, if the flagged content item includes an image of an unclothed baby, then the presence of objectionable material may be more likely when the uploader of the flagged content item is not a family relative or another connection of the baby. Similarly, if the flagged content item includes an image of an unclothed baby, then the presence of objectionable material may be less likely when the uploader of the flagged content item is a family relative or other connection of the baby.

Each feature can be associated with a feature value. For example, a feature value can include a numerical value to indicate a quantitative degree to which the associated feature may apply. As another example, a feature value can include a Boolean value to indicate the presence or absence of information relating to the associated feature. As yet another example, the feature value can include a string value to denote information relating to the associated feature.

The machine learning module 206 can develop a machine learning model (or classifier) to determine the probability that flagged content items include objectionable material. The machine learning model can be based on the features and associated feature values identified by the feature identification module 204. In a supervised learning process, the machine learning module 206 can use determinations resulting from manual review by administrators associated with a social networking system regarding whether flagged content items include objectionable material. The machine learning module 206 can use the determinations resulting from manual review to train and retrain the machine learning model. In some embodiments, the machine learning model can be based on a random forest technique. In other embodiments, the machine learning model can be based on other machine learning techniques.

The machine learning module 206 can periodically or continuously retrain the machine learning model. Retraining of the machine learning model can refine the ability of the machine learning model to accurately determine the probability that a flagged content item includes objectionable material. The machine learning module 206 can retrain the machine learning model based on subsequent determinations resulting from manual review by administrators associated with a social networking system regarding whether flagged content items include objectionable material. As more determinations resulting from manual review regarding the presence of objectionable material in flagged content items are made, the determinations can be provided to the machine learning module 206 to further retrain the machine learning model. Retraining of the machine learning model in this manner can result in optimized precision scores, recall scores, and AUC in relation to the identification of flagged content items including objectionable material.

The machine learning module 206 can develop one or more machine learning models to determine the probability of flagged content items including objectionable material. In some embodiments, the machine learning module 206 can develop different machine learning models to identify objectionable material in different types of flagged content items. For example, the machine learning module 206 can develop a first machine learning model for flagged content items including text, a second machine learning model for flagged content items including an image, a third machine learning model for flagged content items including video, a fourth machine learning model for flagged content items including a combination of text and an image, a fifth machine learning model for flagged content items including a combination of text and video, and so on. In some embodiments, machine learning module 206 can develop different machine learning models to identify objectionable material in flagged content items based on different features. For example, the machine learning module 206 can develop a first machine learning model for flagged content items based on a first set of features and associated feature values. As another example, the machine learning module 206 can develop a second machine learning model for flagged content items based on a second set of features and associated feature values that is different from the first set.

The machine learning module 206 also can perform feature selection in some embodiments. The machine learning module 206 can select a subset of features identified by the feature identification module 204 to develop a machine learning model. The machine learning module 206 can perform feature selection to address data that contains redundant features, which provide no more information than other selected features, or irrelevant features, which provide no useful information.

The evaluation module 208 can determine in an evaluation phase a score indicating a probability that a flagged content item includes objectionable material. The determination of the score can be based on a machine learning model developed by the machine learning module 206. When content items are flagged by users of a social networking system, the flagged content items can be provided to the evaluation module 208. For each flagged content item, the evaluation module 208 can determine a score indicating a probability that the flagged content item includes objectionable material based on the machine learning model. In some embodiments, a score can have a value between 0 and 1, with the value of 1 indicating a highest probability that the flagged content item includes objectionable material. In some embodiments, when different machine learning models have been developed by the machine learning module 206, the evaluation module 208 can select a most relevant machine learning model from the different machine learning models to determine a score for a particular flagged content item.

The sorting module 210 can sort and rank the flagged content items based on their scores. The scores can be ranked in ascending or descending order. Flagged content items that satisfy a threshold value can be provided to the content labeling module 108. The threshold value can be any suitable value. For example, the threshold value can be a selected number of flagged content items that have the highest score. As another example, the threshold value can be a selected absolute value between 0 and 1. The number of flagged content items provided to the content labeling module 108 can be tuned by varying the threshold value. The threshold value can be determined by an administrator of a social networking system. In some embodiments, a threshold value is not needed or not used, and some or all flagged content items can be periodically or continuously presented for further manual review in an order based on their scores.

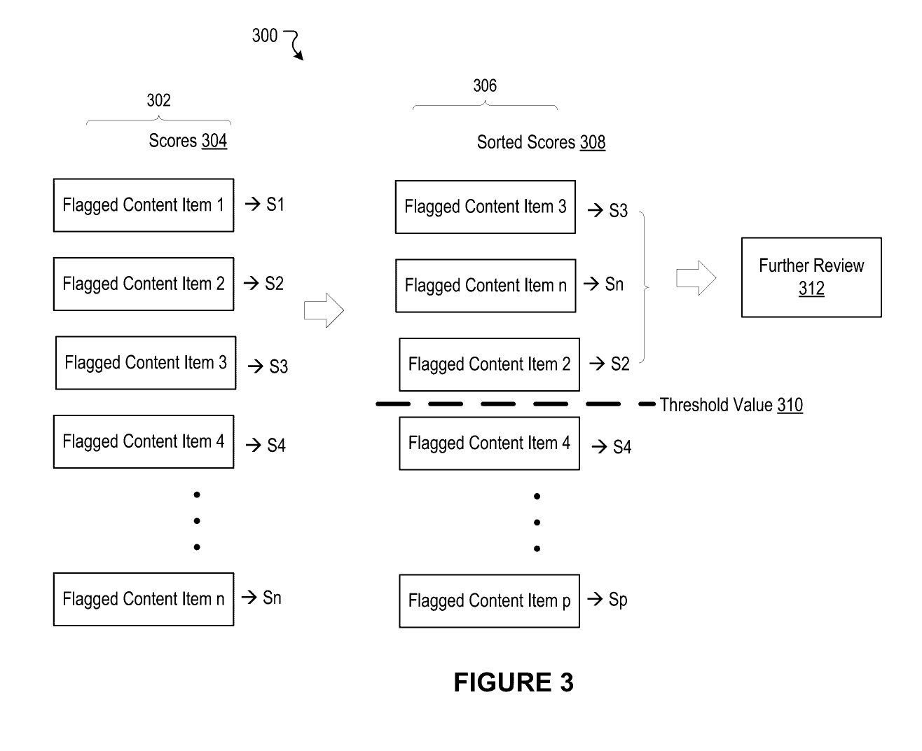

FIG. 3 illustrates an example functional diagram 300 illustrating a selection of flagged content items for further review, according to an embodiment of the present disclosure. The functional diagram 300 includes a collection of flagged content items 302 that have been flagged by users of a social networking system. The functional diagram 300 includes flagged contents items Flagged Content Item 1, Flagged Content Item 2, Flagged Content Item 3, Flagged Content Item 4, and Flagged Content Item n. Any number of flagged content items can be considered.

In a training phase, one or more machine learning models can be developed based on features relating to contextual information associated with flagged content items. In an evaluation phase, scores 304 for the collection of flagged content items 302 can be determined. Each score for a flagged content item can be based on application of a machine learning model to the flagged content item. The score can indicate a probability that the flagged content item includes objectionable material. As shown, Flagged Content Item 1 has a score S1, Flagged Content Item 2 has a score S2, Flagged Content Item 3 has a score S3, Flagged Content Item 4 has a score S4, and Flagged Content Item n has a score Sn.

The collection of flagged content items 302 can be sorted based on the scores 304 to produce a sorted collection of flagged content items 306. The sorted collection of flagged content items 306 and associated sorted scores 308 can reflect, for example, a descending order. As shown, the sorted collection of flagged content items 306 is sorted based on the scores 304 to reflect the following descending order: Flagged Content Item 3, Flagged Content Item n, Flagged Content Item 2, Flagged Content Item 4, and Flagged Content Item p.

A predetermined threshold value 310 can be used to select a subset of the sorted collection of flagged content items 306. As shown, the threshold value 310 appears between Flagged Content Item 2 and Flagged Content Item 4. Satisfaction of the threshold value can identify, for example, a predetermined number of flagged content items having the highest scores or all flagged content items having scores that are greater than or equal to a preselected value. As shown, Flagged Content Item 3, Flagged Content Item n, and Flagged Content Item 2 satisfy the threshold value 310. As a result, Flagged Content Item 3, Flagged Content Item n, and Flagged Content Item 2 can be provided for further review 312 to determine whether they include objectionable material. Further review can involve manual review by an administrator of a social networking system to make such determinations. Such determinations can be used to inform potential remedial measures, such as takedown. Such determinations also can be used to retrain machine learning models to refine their accuracy in determining the probability that flagged content items include objectionable material.

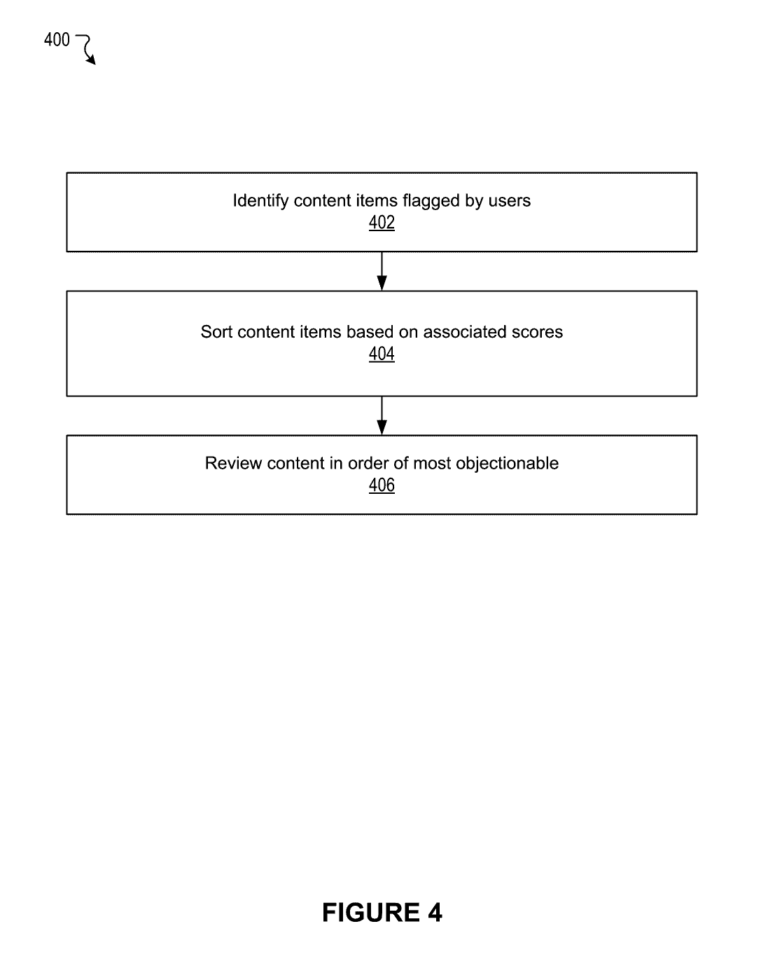

FIG. 4 illustrates an example first method 400 to allow review of flagged content items that may include objectionable material, according to an embodiment of the present disclosure. It should be appreciated that there can be additional, fewer, or alternative steps performed in similar or alternative orders, or in parallel, in accordance with the various embodiments discussed herein unless otherwise stated.

At block 402, the method 400 can identify content items flagged by users. At block 404, the method 400 can sort content items based on associated scores. The scores can be produced based on one more trained machine learning models for determining the probability that flagged content items include objectionable material. At block 406, the method 400 can provide flagged content items for manual review according to their associated scores. The flagged content items associated with the highest scores most likely include objectionable material and therefore can be presented for manual review before other flagged content items having lower scores. Other suitable techniques that incorporate various features and embodiments of the present disclosure are possible.

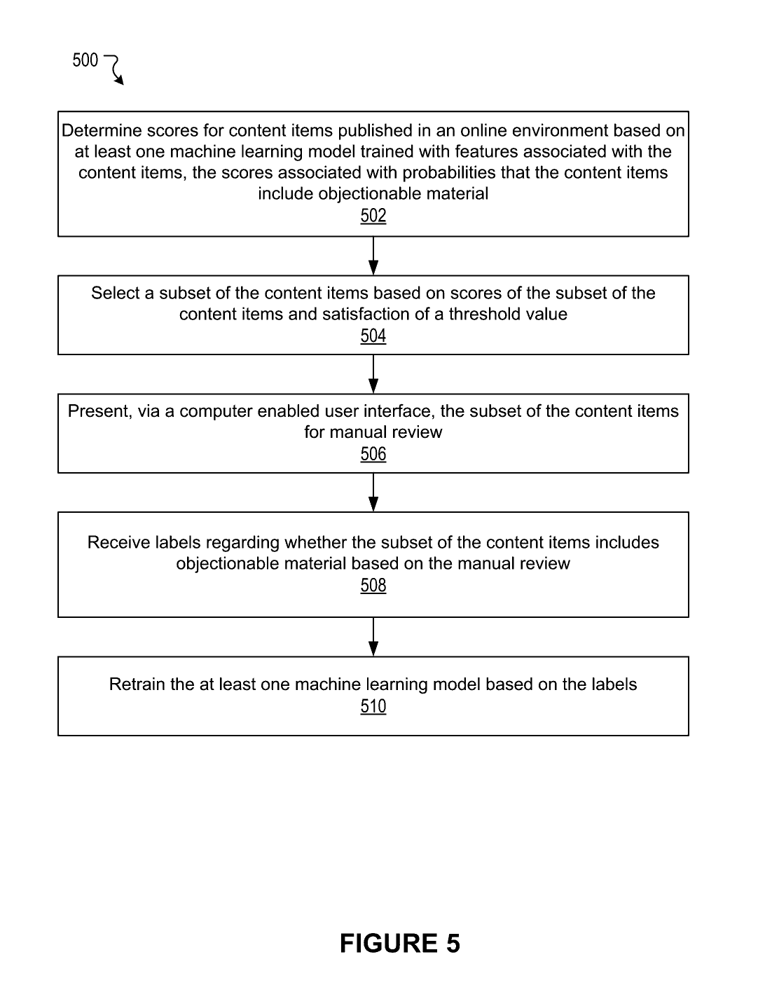

FIG. 5 illustrates an example second method 500 to allow review of flagged content items that may include objectionable material, according to an embodiment of the present disclosure. It should be appreciated that there can be additional, fewer, or alternative steps performed in similar or alternative orders, or in parallel, in accordance with the various embodiments discussed herein unless otherwise stated.

At block 502, the method 500 can determine scores for content items published in an online environment based on at least one machine learning model trained with features associated with the content items, the scores associated with probabilities that the content items include objectionable material. At block 504, the method 500 can select a subset of the content items based on scores of the subset of the content items and satisfaction of a threshold value. At block 506, the method 500 can present, via a computer enabled user interface, the subset of the content items for manual review. At block 508, the method 500 can receive labels regarding whether the subset of the content items includes objectionable material based on the manual review. At block 510, the method 500 can retrain the at least one machine learning model based on the labels. Other suitable techniques that incorporate various features and embodiments of the present disclosure are possible.

### Social Networking System-Example Implementation

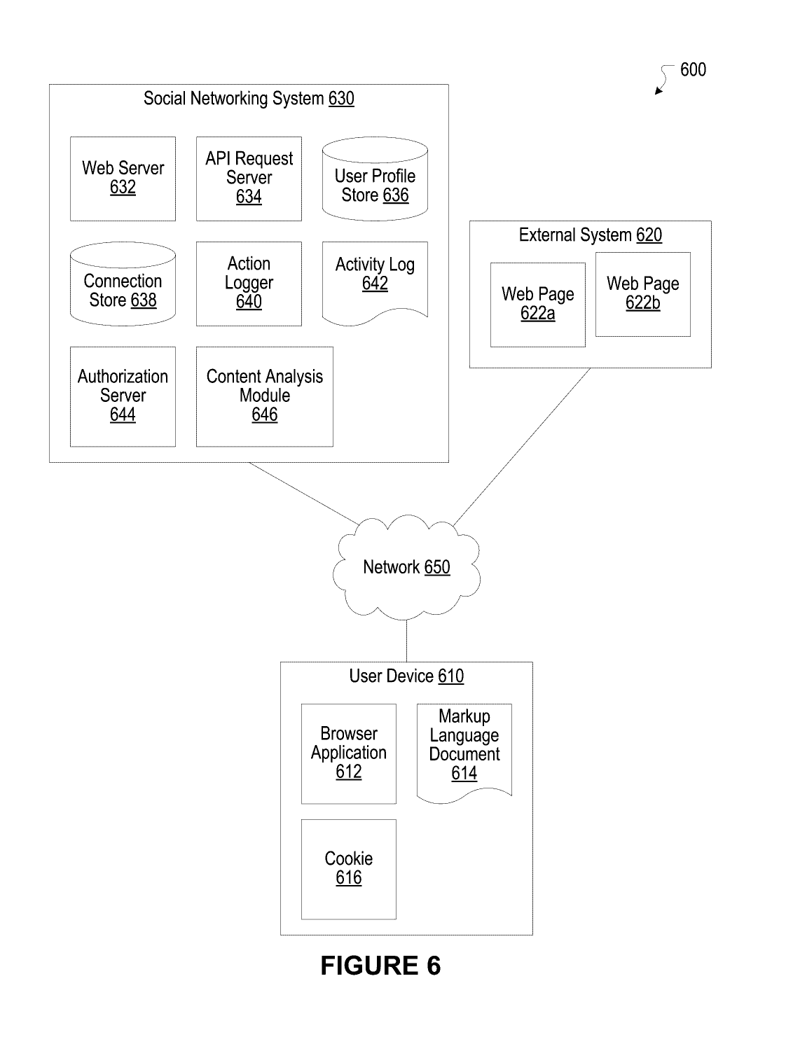

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content analysis module 646. The content analysis module 646 can be implemented with the content analysis module 102, as discussed in more detail herein.

### Hardware Implementation

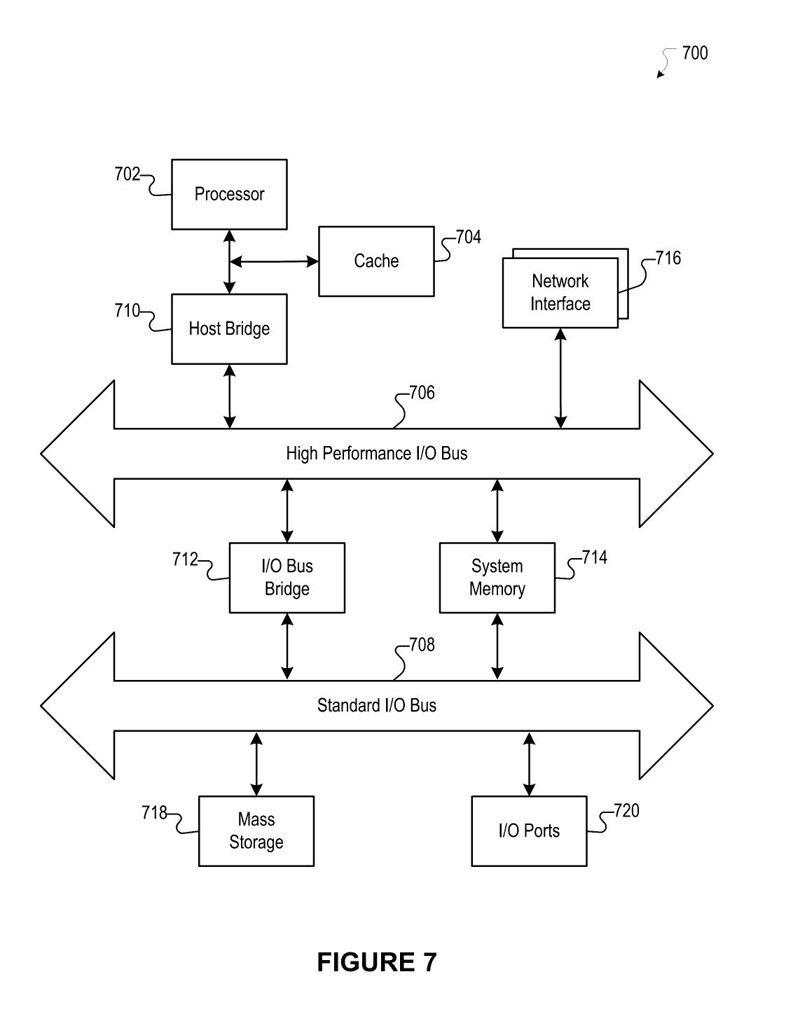

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, scores for content items published in an online environment based on at least one machine learning model trained with features associated with the content items, the scores associated with probabilities that the content items include objectionable material;
selecting, by the computing system, a subset of the content items based on scores of the subset of the content items and satisfaction of a threshold value; and
determining, by the computing system, whether the subset of the content items includes objectionable material.

2. The computer-implemented method of claim 1, wherein the features reflect contextual information regarding the content items.

3. The computer-implemented method of claim 2, wherein the features relate to at least one of a user who flagged a content item and a user who uploaded a flagged content item.

4. The computer-implemented method of claim 3, wherein the features include at least one of reporting accuracy, abuse history, gender, age, profile completeness, profile verification, locale, friends counts, account age, number of reporters, language, and topics reflected by the content items.

5. The computer-implemented method of claim 1, wherein the content items include flagged content items.

6. The computer-implemented method of claim 1, wherein the at least one machine learning model is based on a random forest technique.

7. The computer-implemented method of claim 1, wherein the at least one machine learning model includes different machine learning models, the method further comprising developing the different machine learning models to identify objectionable material in different types of content items.

8. The computer-implemented method of claim 1, further comprising sorting the content items based on the scores.

9. The computer-implemented method of claim 1, wherein the determining whether the subset of the content items includes objectionable material comprises:
presenting, via a computer enabled user interface, the subset of the content items for manual review; and
receiving labels regarding whether the subset of the content items includes objectionable material based on the manual review.

10. The computer-implemented method of claim 9, further comprising retraining the at least one machine learning model based on the labels.

11. A system comprising:
at least one processor; and
a memory storing instructions that, when executed by the at least one processor, cause the system to perform:
determining scores for content items published in an online environment based on at least one machine learning model trained with features associated with the content items, the scores associated with probabilities that the content items include objectionable material;
selecting a subset of the content items based on scores of the subset of the content items and satisfaction of a threshold value; and
determining whether the subset of the content items includes objectionable material.

12. The system method of claim 11, wherein the features reflect contextual information regarding the content items.

13. The system method of claim 12, wherein the features relate to at least one of a user who flagged a content item and a user who uploaded a flagged content item.

14. The system method of claim 13, wherein the features include at least one of reporting accuracy, abuse history, gender, age, profile completeness, profile verification, locale, friends counts, account age, number of reporters, language, and topics reflected by the content items.

15. The system method of claim 11, wherein the content items include flagged content items.

16. A non-transitory computer-readable storage medium including instructions that, when executed by at least one processor of a computing system, cause the computing system to perform a method comprising:
determining scores for content items published in an online environment based on at least one machine learning model trained with features associated with the content items, the scores associated with probabilities that the content items include objectionable material;
selecting a subset of the content items based on scores of the subset of the content items and satisfaction of a threshold value; and
determining whether the subset of the content items includes objectionable material.

17. The non-transitory computer-readable storage medium of claim 16, wherein the features reflect contextual information regarding the content items.

18. The non-transitory computer-readable storage medium of claim 17, wherein the features relate to at least one of a user who flagged a content item and a user who uploaded a flagged content item.

19. The non-transitory computer-readable storage medium of claim 18, wherein the features include at least one of reporting accuracy, abuse history, gender, age, profile completeness, profile verification, locale, friends counts, account age, number of reporters, language, and topics reflected by the content items.

20. The non-transitory computer-readable storage medium of claim 16, wherein the content items include flagged content items.
